(19) United States
(12) Patent Application Publication
(10) Pub. No.: US 2015/0129171 A1
(43) Pub. Date: May 14, 2015

(54) METHOD AND APPARATUS FOR CLEANING SURFACES OF A FINNED HEAT EXCHANGER

(71) Applicant: Jens Werner Kipp, Bielefeld (DE)

(72) Inventor: Jens Werner Kipp, Bielefeld (DE)

(21) Appl. No.: 14/404,991

(22) PCT Filed: Jul. 23, 2013
(86) PCT No.: PCT/DE2013/100273

§ 371 Date: Dec. 2, 2014

(30) Foreign Application Priority Data
Jul. 24, 2012 (DE) 10 2012 014 605.1

(51) Int. Cl. F28G 9/00; B08B 3/02

(52) U.S. Cl. CPC F28G 9/00; B08B 3/02
USPC 165/95

(57) ABSTRACT

A method for cleaning surfaces of a finned heat exchanger, wherein compressed air and water are used for cleaning and the compressed air is supplied to a jet nozzle (1), which has a section (7) converging to a constriction (6) and a subsequent diverging section (8), and the water or another liquid substance is fed into the flow of compressed air preferably upstream of the jet nozzle (1), or in a different embodiment upstream of, in or downstream of the constriction (6) in the jet nozzle. The jet nozzle (1) is directed at the cavity in a finned heat exchanger formed by the fins. The jet penetrates the cavity between adjacent fins for the purpose of cleaning the fin surfaces.

The invention relates to a method for cleaning the plates or fins of heat exchangers, which could also have larger depths, wherein the invention also relates to a device for cleaning such surfaces.

### STATE OF THE ART

It is already known to supplementally use compressed air in high pressure cleaning equipment (from 800 bar pressure). In this case, larger amounts of water are charged with relatively small amounts of air in order to obtain a higher cleaning effect. Because here overwhelmingly water quantities are ejected with high pressure, a considerable force is applied to the parts to be cleaned, which can cause damage. For many surfaces only a low water pressure is manufacturer-approved, which mostly does not develop enough cleaning power. A water pressure of for example greater than 10 bar or the addition of abrasives, even the softer kind, can here already lead to the destruction of parts or an undesirable roughening of the surfaces.

Cleansing of plate or finned heat exchangers with a high pressure cleaner can lead to considerable damage, especially when the jet device is not angled exactly 90° to the sensitive fins. Here, the high-pressure stream of water emitted from the nozzle impinges obliquely on the sensitive fins, which can lead to significant damage.

Chemical cleaning agents are also used for cleansing, which then need to be removed again by water jet cleaning, wherein here larger amounts of chemical contaminated wastewater is produced. This effluent has to be caught—if at all possible—on the Earth's surface. For this purpose, the area around the finned heat exchanger must be protected to prevent damage to the environment.

Cleaning a plate or finned heat exchanger with only a water jet has, for the most part, not produced a satisfying cleaning effect.

### Task

Aim and purpose of the invention is to provide a method and a device for cleaning heat exchanger plates or fins, having a gentle yet effective cleaning effect at a low application of water and with the avoidance of chemicals.

### Solution

According to the invention this problem is solved by the features of claims 1 and 11, advantageous embodiments and further developments of the invention will become apparent from the subsequent dependent claims.

The advantages achieved with the invention are comprised thereof, that by means of a low-pressure cleaning process using compressed air and small amounts of water as blasting medium, a cleaning method is provided which is particularly suitable for the cleaning of heat exchanger plates or fins. Since compressed air with a small amount of water has a much lower density than a jet of water, and in addition can be brought to a very high speed by a corresponding nozzle, full penetration of the heat exchanger is achieved even at low pressure of the carrier gas.

The use of a low pressure jet, which is generated only by means of compressed air and a small amount of pure water with no additives, allows a gentle but effective cleaning of the fins in the entire construction depth of the heat exchanger. The surfaces of fins to be cleaned are aligned parallel to the jet. Since, in contrast to the use of the method on other surfaces, such as graphite or foils, the beam angle of the surfaces to be cleaned is near to 0°, the jet pressure exerted on the surfaces is very low here. The surprising cleaning effect here can not be attributed to the impact of the jet on the surface, but rather results surprisingly from the friction effect of the jet on the surfaces of the plates or fins A pulsating of the jet contributes here to the cleaning action. The problem is inventively overcome in that compressed air is supplied to a jet nozzle which has a converging throat portion and an adjoining diverging section, and that the water is introduced into the carrier gas stream preferably before the constriction, or where appropriate in or downstream of the throat of the nozzle, and is accelerated to a high speed, at least close to the speed of sound or supersonic speed. Tests have shown that even at a relatively low pressure of the compressed air starting from 1 bar, preferably from 1.5 bar, and thus a low jet impact pressure, complete penetration of the jet through the finned heat exchanger is achieved. For the cleaning of heat exchangers with larger construction depths, of the jet pressure can be increased the jet pressure can be increased to the extent tolerated by the fins. Thereby even solidified or sticky layers of dirt are removed without bending or otherwise damaging the thin fins. To achieve a uniform cleaning with little overlap areas a flat nozzle is preferably used. A flat nozzle when used in the cleaning of “normal” surfaces often exhibits a smaller cleaning effect when compared to a circular nozzle, however, in the cleaning of finned heat exchangers, the jet passes more effectively into the narrow channels of the plate-fin heat exchanger, since the impact effect on the front side of the exchanger is strongly reduced. This leads to an improved and more uniform cleaning effect.

In a practical embodiment the flow rate of the carrier gas is 4000 liter per min, preferably 6,000 liter per min. The amount of water supplied in liters should be, in proportion to the compressed air, preferably be less than 1:1000. The supplied water should be metered in at a distance of at least 30 mm upstream of the constriction of the jet at a pressure of at least 50% of the pressure of the compressed air, but preferably be similar to or higher than the pressure of the compressed air. In the case of a dosing in of the supplied water at a distance of less than 30 mm from the nozzle throat, and at or downstream of the nozzle throat, the water pressure can be reduced as a function of the decreasing pressure with increase in speed of the compressed air or introduced without pressure. The water is then sucked in by the high flow velocity of the water.

Tests have also shown that even at relatively low pressure of the compressed air of for example 1.5 bar and thus a relatively low jet impact pressure a high-pressure cleaner with superior high cleaning effect is already achieved, able to remove any solid or sticky dirt layers, without attacking the underlying surface or damaging the fins. In addition to the effect achieved by the high friction rate of the compressed air and the fine water droplets homogeneously distributed in the compressed air, the pulses of a pulsating jet also contribute in to the cleaning success.

In this advantageous embodiment of the invention, the jet may be induced to pulsate by the design of the water pump and/or with appropriate valves in the water and/or compressed air supply, which leads to an enhancing of the cleaning effect. In the case that the existing water pressure is adequate, an additional pump to increase the pressure of the water can also be dispensed with. An improvement of the cleaning effect can also be achieved by heating of the compressed air or medium, for example, by means of heat exchanger, to clean for example heavily oil-contaminated surfaces faster and more successfully. The required water preferably has drinking water quality, but also properties near to drinking water quality. For special requirements there is there is also the possibility of improvement in the effect by changing the pH of the water.

The objective and purpose of the invention is, in addition to the provision of the process, the provision of an device for carrying out the cleaning of the plates or fins of a plate or finned heat exchanger. For cleaning, preferably only compressed air and water are used. The device here comprises a jet nozzle with a source of compressed air, wherein the jet nozzle has a section converging to a throat section and a subsequent diverging section. Next a feed line for the water is provided, which is designed for the addition of water before, in or after the jet nozzle. At a feeder for the water which serves as an abrasive, the volume of the amount of water to the volume of the compressed air in the ratio is less than 1:1000, preferably less than 1:2000.

Herein the jet nozzle is preferably of a convergent-divergent design, preferably a Laval nozzle. In the liquid supply a suitable throttle valve is provided upstream of the jet device to regulate the amount of water. Thereby the water/liquid is fed to the carrier gas directly or via a distribution chamber with at least one outlet port. A diaphragm pump or a piston pump is preferably provided to transport the water/liquid. The displacement thereof should be less than 1.00 liter. A pressure amplifier may be arranged behind the membrane pump. Interrupter valves can be provided for generating a pulsed nozzle stream of water and/or compressed air, and in addition changing pipeline diameters from the water supply up to the pump can also bring about desired pressure changes of the water.

The transport of water can be facilitated through any kind of pumps, preferably by a membrane pump or piston pump, which suck the water, but can also occur under water hose pressure. An advantage of using a compressed air-powered water pump is that no additional electrical power supply is required, whereby hour meters, etc. can be powered by small batteries or other external power sources.

When installing a pressure amplifier downstream of the diaphragm pump or piston pump, the pressure of the control air can be kept small, whereby the water pressure can be increased, however, well above the control pressure.

The generation of a pulsed jet stream can hereby be by the design of the pump as a diaphragm pump and/or through the use of the interrupter valves for water and/or compressed air. The pipe from water supply up to the pump may have different diameters.

According to a further preferred embodiment of the device, demineralization of water takes place prior to being introduced into the device, or in a system in the device having (e.g. osmosis or ion exchange system).

The use of a flat nozzle is particularly advantageous for the device. For cleaning hard to reach areas, the use of an injection lance with adjustable jet angle is particularly advantageous.

### DESCRIPTION OF THE DRAWINGS

An embodiment of the invention is illustrated purely schematically in the drawings and will be described in greater detail below. In the drawings:

FIG. 1 is a sectional view of a nozzle according to the invention in a first embodiment,

FIG. 2 is a sectional view of a nozzle according to the invention in a second embodiment,

FIG. 3 is a sectional view of a nozzle according to the invention in a third embodiment and

FIG. 4 is a sectional view of a nozzle according to the invention in a fourth embodiment.

### EMBODIMENTS

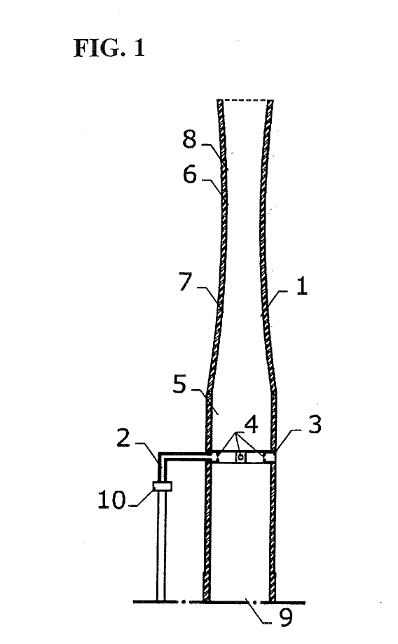

FIG. 1 shows in sectional view a jet nozzle 1, wherein the line 2 serving for supply of the water discharges into a distribution chamber 3, and from there is fed through the outlets 4 into the spray line 5, which flows into the nozzle 1. In this case, the pressurized compressed air 9 and water, or other liquid substance, are supplied to the nozzle 1. The jet nozzle 1 in this case has a converging section 7 leading to a narrow 6 section and a subsequent diverging section 8. Here, water or another liquid substance are metered into the flow of compressed air, preferably before the jet nozzle 1, in a different version before, in or after the narrow section 6 of nozzle 1.

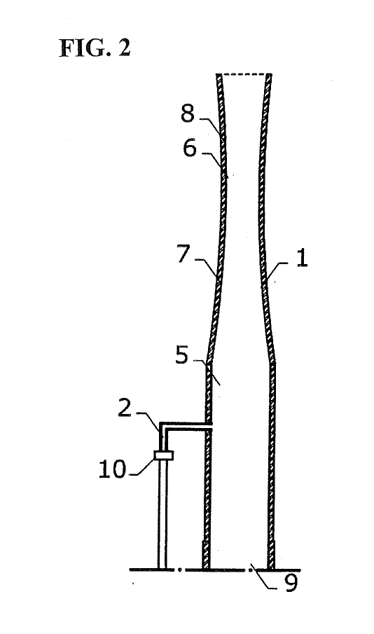

FIG. 2 shows another example of a nozzle 1, wherein the line 2 serving for supply of the water opens directly into the flow line 5.

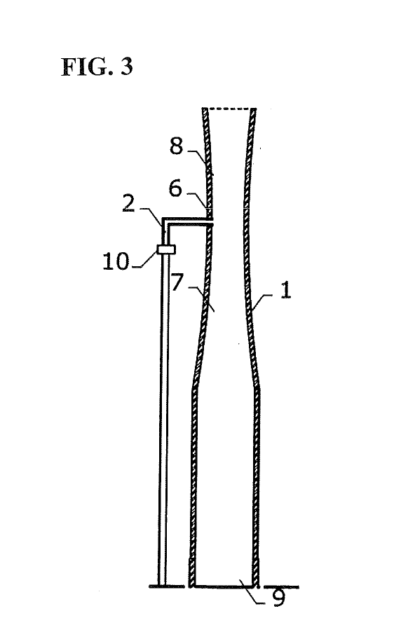

FIG. 3 shows another example of a jet nozzle 1, wherein the line 2 serving for the supply of the water opens into the jet nozzle 1 directly in front of the constriction 6.

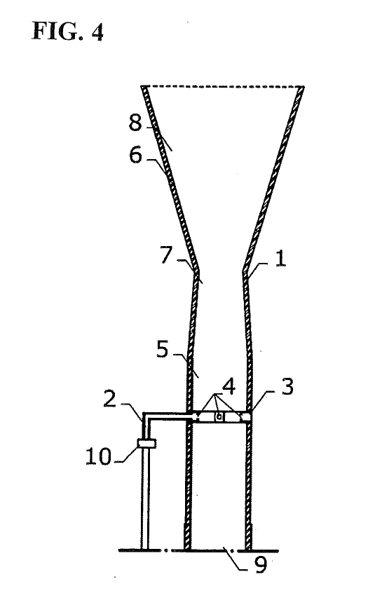

FIG. 4 shows a modified example of the flat spray nozzle 1, in which the line 2 serving for supply of the water opens into a distribution chamber 3, and is then fed through the outlet 4 into the flow line 5, which opens into the nozzle 1.

In the inventive method and the device of the invention, a carrier gas other than air can and another liquid substance other than water can be used.

### REFERENCE NUMBER LIST

01 jet nozzle

02 line

03 distribution chamber

04 outlet

05 flow line

06 constriction

07 section

08 section

09 carrier gas/compressed air

10 pressure regulator or choke valve

1. A method for cleaning surfaces of a plate or finned heat exchanger, wherein compressed air and water are used for generating a jet stream for cleaning, comprising
supplying the compressed air to a jet nozzle (1), which has a converging section (7) leading to a constriction (6) and a subsequent divergent section (8), and
introducing the water or other suitable liquid substance into the flow of compressed air upstream of the constriction of the blasting nozzle (1) or in or after the constriction (6) of the nozzle to form a jet stream comprising air and water,
directing the jet nozzle (1) to the cavity formed between the plates or fins of a plate or finned heat exchanger, so that the jet stream for cleaning the plate or fin surfaces penetrates the cavity existing between the adjacent plates or fins.

2. The method according to claim 1, wherein the water is supplied at a pressure,
wherein in the case of introduction of water at a distance of at least 80 mm upstream of the throat of the nozzle (1), the water pressure is equal to or above the pressure of the compressed air or at least 80% of the pressure of the compressed air,
wherein at an introduction at a range of less than 80 mm upstream of the constriction (6) of jet nozzle (1), and in or after the constriction (6) of the nozzle (1), the water can be introduced with a decrease in the pressure depending upon the decrease in pressure associated with the increase in speed, or introduced without pressure taking advantage of the suction effect.

3. The method according to claim 1, wherein the quantity of water/liquid introduced in relation to the compressed air by volume is less than 1:1,000, preferably less than 1:2000.

4. The method according to claim 1, wherein the pressure of the carrier gas is at least 1.5 bar.

5. The method according to claim 1, wherein the mixture of compressed air and water in the nozzle (1) is accelerated to a high speed, preferably approximately the speed of sound or supersonic speed.

6. The method according to claim 1, wherein the jet nozzle (1) is a flat nozzle, in order to achieve an effective, gentle and uniform cleaning of the plates or fins without any damage.

7. The method according to claim 1, wherein the flow velocity of the mixture of compressed air and water is varied by means of a throttle valve or pressure reducer (10) in the liquid supply (2) and/or a throttle valve or pressure reducing valve in the compressed air supply (9).

8. The method according to claim 1, wherein the water and/or compressed air are preferably fed pulsating to the jet nozzle (1).

9. The method according to claim 1, wherein the compressed air is supplied with heating, for example by means of a heat exchanger.

10. The method according to claim 1, wherein the water is supplied at an elevated pH.

11. A device for performing the method for cleaning of plate or finned heat exchangers with a supply of compressed air (9), which opens into a nozzle (1) having a converging section (7) leading to a constriction (6) and a subsequent divergent section (8), and also with a supply (2) for of water serving as a blasting agent, wherein the amount of water to the amount of carrier gas is in a ratio of less than 1:1000.

12. The device according to claim 11, wherein the nozzle (1) is a Laval nozzle.

13. The device of claim 11, wherein the jet nozzle (1) is formed as a flat nozzle.

14. The device according to claim 11, wherein in the liquid feed upstream of the jet device (1), a suitable throttle valve (10) is provided for regulating the amount of water.

15. The device according to claim 11, wherein the water is supplied through a direct feed (3) and/or at least the outlet opening (4) into the compressed air.

16. The device according to claim 11, wherein a pump is provided for conveyance of the water, preferably a diaphragm pump or a piston pump.

17. The device according to claim 11, wherein by the configuration of the membrane or piston pump a pulse can be generated in the jet stream.

18. The device according to claim 11, wherein a pressure amplifier is mounted downstream of the diaphragm or piston pump.

19. The device according to claim 11, wherein interrupter valves for water and/or compressed air s are provided as means for generating a pulsating jet stream.

20. The device according to claim 11, wherein a pressure change of the water is provided by changing the pipe diameter between the water supply and the pump.
